(19) United States
(12) Patent Application Publication
(10) Pub. No.: US 2006/0257725 A1
(43) Pub. Date: Nov. 16, 2006

(54) Energy Storage Cell Support Separator System for a Multiple Cell Module and Method of Use

(75) Inventor: Michael D. Wilk, Temecula, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 11/459,754

(22) Filed: Jul. 25, 2006

Related U.S. Application Data
(63) Continuation-in-part of application No. 10/951,671, filed on Sep. 28, 2004.
Application No. 10/951,671 is a continuation-in-part of application No. 10/720,916, filed on Nov. 24, 2003, now Pat. No. 7,085,112.
Application No. 10/720,916 is a continuation-in-part of application No. 09/972,085, filed on Oct. 4, 2001, now Pat. No. 6,714,391.

(51) Int. Cl. H01M 2/10; H01M 2/24

(52) U.S. Cl. 429/99; 429/100; 429/159

(57) ABSTRACT

A system of rigid insulating insert separators for mounting energy storage cell canisters within a sealed module of multiple energy storage cell canisters to maintain the exact position of the energy storage cell canisters to eliminate stress and resistance variation at the point of contact between the bus bar interconnections and the cell terminals. The separators also have provision for mounting balancing circuit boards between the energy storage cell canisters and allowing wiring connections between the circuit boards and the bus bar interconnections.

### RELATED APPLICATIONS

This patent application is a continuation-in-part application of U.S. patent application Ser. No. 10/951,671 filed Sep. 28, 2004, which is a continuation-in-part application of U.S. patent application Ser. No. 10/720,916 filed Nov. 24, 2003, which is a continuation-in-part application of U.S. patent application Ser. No. 09/972,085 filed Oct. 4, 2001, now U.S. Pat. No. 6,714,391. This application claims the benefit of these prior applications and these applications are incorporated by reference herein as though set forth in full.

### FIELD OF THE INVENTION

The field of the invention relates to the mounting and the support of energy storage cell canisters within a multi-cell energy storage module.

### BACKGROUND OF THE INVENTION

A multi-cell energy storage module (e.g., ultracapacitor module) may include a plurality of energy storage cell canisters (e.g., ultracapacitors) electrically connected together in series, physically end-to-end, to form a higher-voltage module. The cylindrical energy storage cell canisters may be electrically connected by means of rectangular bus bar interconnections with holes at each end to fit over circular end terminals of two energy storage cell canisters. A problem that has occurred in some of these multi-cell modules is that the energy storage cell canisters were not adequately supported relative to each other (i.e., not precisely fixed relative to each other). As a result, relative movement of the energy storage cell canisters caused the bus bar interconnections to flex. Over time, the flexing bus bar interconnection compromises the interconnection integrity, resulting in a high interconnection resistance. The high resistance lowers the efficiency of the energy storage and causes excessive heat generation that can destroy or shorten the life of the energy storage cell canisters.

### SUMMARY OF THE INVENTION

An aspect of the present invention involves a system and a method to support and maintain a precision location of each energy storage cell canister within a multi-cell energy storage module. Rigid, form-fitting, non-conducting, high-temperature separator inserts are used to support the energy storage cell canisters and maintain exact energy storage cell canister position.

Another aspect of the invention involves a system for mounting energy storage cell canisters within a multi-cell energy storage module, the energy storage cell canisters having an outer surface, a central longitudinal axis, and opposite ends. The system includes a plurality of shaped separator inserts to position and support the energy storage cell canisters, the plurality of shaped separator inserts configured to extend substantially perpendicularly relative to central longitudinal axis of the energy storage cell canisters; and a plurality of bus bar interconnections to electrically connect the energy storage cell canisters.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1A is a front elevational view of an embodiment of a first separator insert of a multi-cell energy storage module;

FIG. 1B is a front elevational view of an embodiment of a second separator insert of a multi-cell energy storage module;

FIG. 2A is a perspective view of the first separator insert illustrated in FIG. 1A;

FIG. 2B is a perspective view of the second separator insert illustrated in FIG. 1B;

FIG. 3A is a front elevational view of an embodiment of a multi-cell energy storage module with the front of the multi-cell energy storage module removed;

FIG. 3B is rear elevational view of the multi-cell energy storage module of FIG. 4A with the rear of the multi-cell energy storage module removed;

FIG. 4A is a perspective view of an alternative embodiment of a separator insert of a multi-cell energy storage module;

FIG. 4B is a front elevational view of an alternative embodiment of a multi-cell energy storage module with the front of the multi-cell energy storage module removed.

### DETAILED DESCRIPTION OF A PREFERRED EMBODIMENT

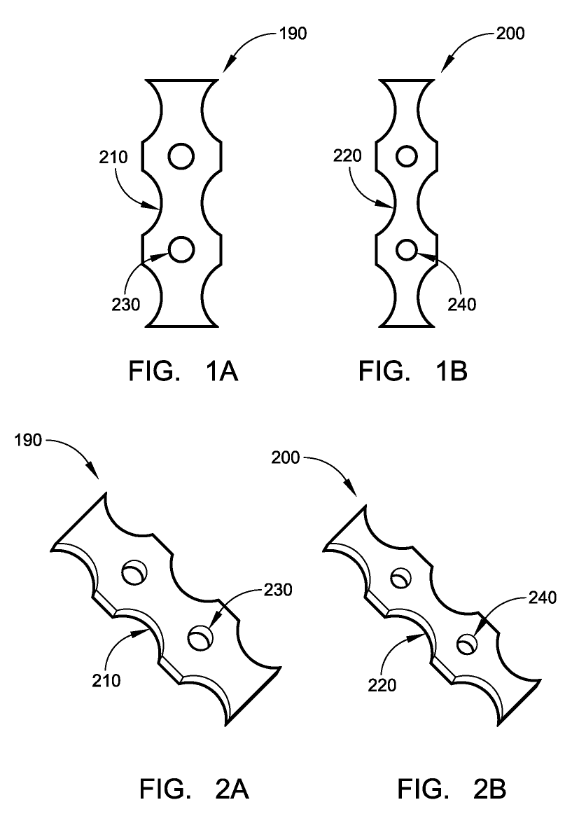

With reference to FIGS. 1-3, an embodiment of an energy storage cell support separator system 100 for a multiple-cell energy storage module 110 and method of using the same will be described.

In the embodiment shown, the multiple-cell energy storage module 110 is a Maxwell MC BMOD Energy Series 48V BOOSTCAP® brand Ultracapacitor Module made from Maxwell BOOSTCAP® brand ultracapacitor energy storage cell canisters. The module 110 includes eighteen (18) cylindrical energy storage cell canisters (i.e., cells, cans) 120 arranged in three rows of six energy storage cell canisters 120. In alternative embodiments, the invention is applied to other multiple-cell energy storage modules.

The energy storage cell canisters 120 are aluminum cylindrical cans approximately 2.27 inches in diameter and 6 inches in length with terminals 130 protruding from each end of the energy storage cell canister 120 for the electrical terminal connection. The ultracapacitor energy storage cell canister 120 is polarized with the negative side terminal connected to the body of the energy storage cell canister 120 and the positive side terminal insulated from the body of the energy storage cell canister 120.

The energy storage cell canisters 120 are electrically connected by means of thin, rectangular bus bar interconnections 140, 150 with 0.54 inch diameter holes at each end to fit over the circular end terminals 130 of two energy storage cell canisters 120. Because the energy storage cell canisters 120 are spaced wider apart in a center 160 of the module 100, the bus bar interconnections 150 connecting across two middle columns 170, 180 of energy storage cell canisters 120 are 2.85 inches long whereas the other bus bar interconnections 140 are only 2.44 inches long.

During the assembly process the bus bar interconnections are heated to expand the holes, placed over the energy storage cell canister terminals, and allowed to cool for a shrunken press fit. The exterior of the energy storage cell canister 120 is electrically active, being connected to the negative side of the energy storage cell canister 120.

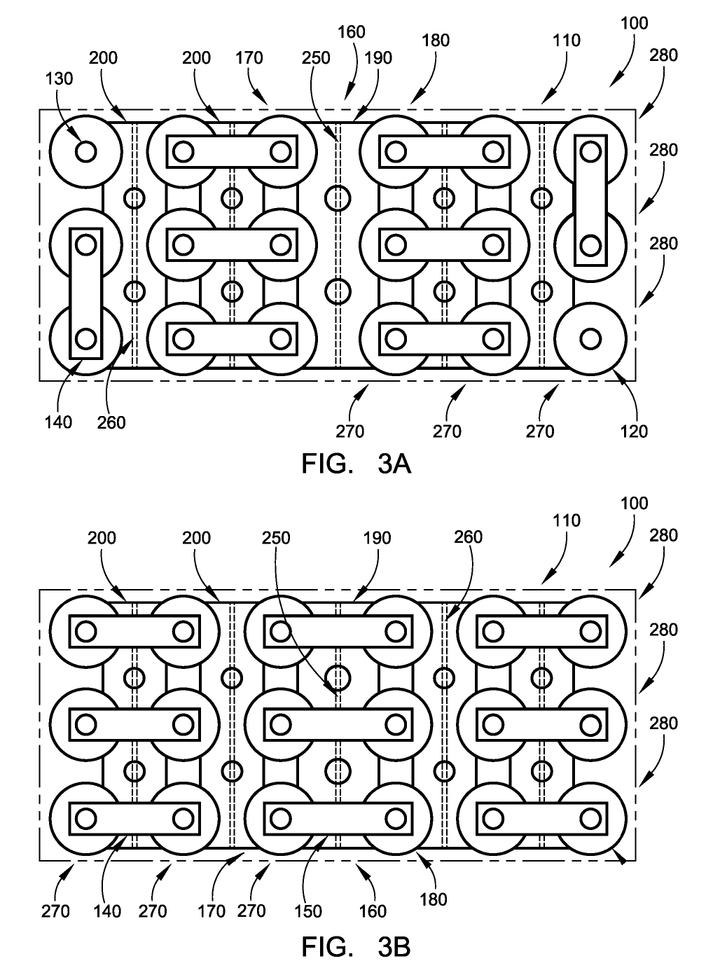

Separator inserts 190, 200 are made of high-temperature, ⅝-inch thick, electrically insulating nylon plastic. The separator inserts 190, 200 include incurved lateral sections 210, 220, which are machined into the nylon separator inserts 190, 200, to match the outer curved exterior of the energy storage cell canisters 120. The location of the incurved lateral sections 210, 220 are determined by the desired position of the energy storage cell canisters 120 within the module 110. Holes 230, 240 are drilled into the separator inserts 190, 200 to provide for wiring access to circuit boards 250, 260 (FIGS. 3A, 3B) located between front and rear separator inserts 190, 200 in the module 110. The size and location of the holes 230, 240 are determined by the wire feed-through requirements and the structural integrity of the separator inserts 190, 200. In the embodiment shown, the diameters of the energy storage cell canisters 120 and the vertical spacing of the energy storage cell canisters 120 are constant through the module 110. In alternative embodiments, the separator inserts 190, 200 are shaped to accommodate alternative energy storage cell canister configurations and spacing. In further embodiments, the separator inserts 190, 200 do not have holes, or have holes with different sizes, configurations, and/or positions that those shown.

Two three-can separator inserts 190, 200 are installed substantially perpendicular to the cylindrical axis of the energy storage cell canisters near the ends of the energy storage cell canisters (front, back of the module 110) in the five spaces between the six columns 270 of energy storage cell canisters 120, for a total of 10 separator inserts. As shown in FIGS. 1A, 1B 2A, 2B, separator insert 190 is wider than separator insert 200 to accommodate the extra width in the space at the center 160 of the module 110 between two middle columns 170, 180 of energy storage cell canisters 120

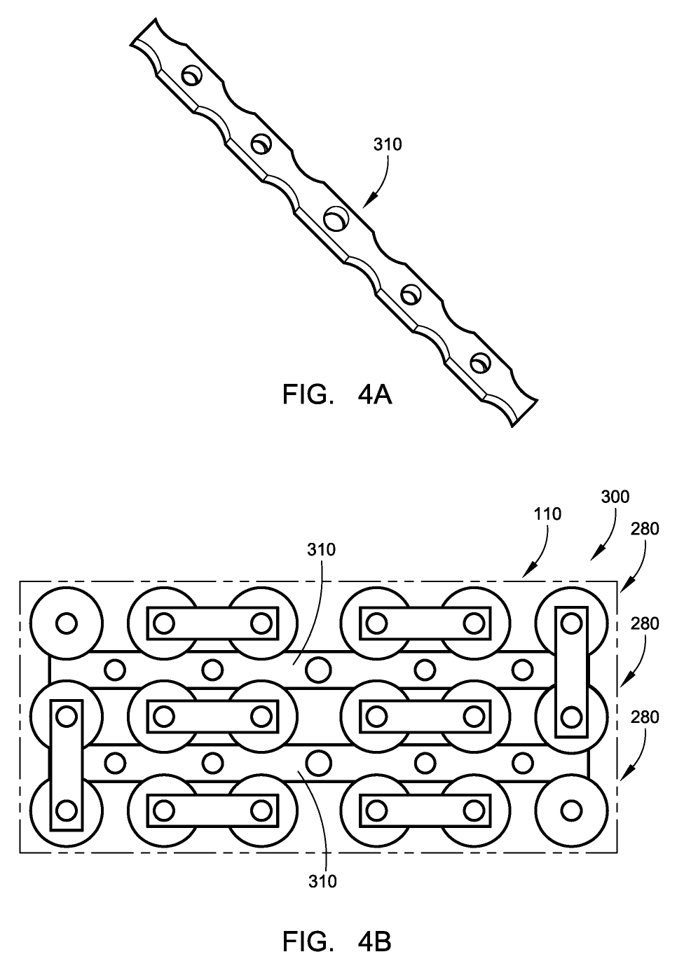

With reference to FIGS. 4A and 4B, an alternative embodiment of an energy storage cell support separator system 300 is shown. In this embodiment, two six-can separator inserts 310 are installed substantially perpendicular to the cylindrical axis of the energy storage cell canisters 120 near the ends of the energy storage cell canisters 120 (front, back of the module 110) in the two spaces between the three rows 280 of energy storage cell canisters 120, for a total of four separator inserts.

In a further embodiment, the module 110 includes a mounting sheet or mounting plate that includes cut outs and/or holes to support and position the energy storage cell canisters 120 within the sealed module 110.

In the embodiment shown, five balancing circuit printed circuit boards 250, 260, one for each space between energy storage cell canister columns 270, fit between the front, back separator inserts 190, 200. The printed circuit boards 250, 260 also have insulated separator inserts to position the circuit boards 250, 260 between the energy storage cell canisters 120 of adjacent columns 270. Insulated wires from the circuit boards 250, 260 pass through holes 230, 240 in the separator inserts 190, 200 and are riveted to the bus bar interconnections 140, 150 to form the connections required for the balancing circuits. The circuit boards 250, 260 add to the structural rigidity of the separator inserts 190, 200 to further help prevent the energy storage cell canisters 120 from moving and putting stress on the bus bar interconnections 140, 150 and end terminals 130. The circuit boards 250, 260 are held in place vertically by the module outside enclosure. In an alternate embodiment, grooves are cut in the nylon separator inserts 190, 200 to position and support the circuit boards 250, 260.

The circuit boards 250, 260 contain equalization and balancing circuits for the energy storage cell canisters 120 connected in series within the module 110. In an alternative embodiment, one or more of the circuit boards 250, 260 also contain communication circuits that report the module status external to the module 110. To connect the balancing circuits to the end terminals 130 of the energy storage cell canisters 120 wires pass through the holes 230, 240 in the separator inserts 190, 200 and are riveted to the bus bar interconnections 140, 150 through predrilled holes, not shown.

A method of manufacturing a multi-cell energy storage module 110 and/or retrofitting an existing multi-cell energy storage module 110 includes, first, shaping the separator inserts 190, 200 from ⅝-inch thick nylon plastic separator inserts. Each nylon plastic block is machined to the proper dimensions to fit the energy storage cell canisters 120 and their position within the module 110. Next, the electrical balancing and equalization circuits and circuit boards 250, 260 are manufactured. The nylon separator inserts 190, 200, supports for the circuit boards 250, 260, and the circuit boards 250, 260 are placed in the spaces between the columns 270 inside the module 110. Finally, the wires from the circuit boards 250, 260 are fed through the holes 230, 240 in the nylon separator inserts 190, 200 and riveted to the interconnection bars 140, 150. In alternative embodiments, materials other than hard nylon plastic are used and/or other methods of forming the material to the desired shape are used.

The separator inserts 190, 200 rigidly support the energy storage cell canisters 120 in exact cell position relative to each other. A rigid and exact cell position is necessary to maintain the integrity and low electrical resistance of interconnecting bus bar interconnections 140, 150. Also, consistent spacing has to be maintained for active balance circuit printed circuit boards (PCBs) to fit properly between the energy storage cell canisters 120.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A system for mounting energy storage cell canisters within a multi-cell energy storage module, the energy storage cell canisters having an outer surface, a central longitudinal axis, and opposite ends, comprising:
a plurality of shaped separator inserts to position and support the energy storage cell canisters, the plurality of shaped separator inserts configured to extend substantially perpendicularly relative to central longitudinal axis of the energy storage cell canisters; and
a plurality of bus bar interconnections to electrically connect the energy storage cell canisters.

2. The system of claim 1, wherein the shaped separator inserts are made from a hard plastic insulating material.

3. The system of claim 2, wherein the shaped separator inserts are made from a hard nylon.

4. The system of claim 1, wherein the shaped separator inserts are shaped to match and receive the outer surface of the energy storage cell canisters.

5. The system of claim 1, wherein the shaped separator inserts include holes for wiring access.

6. The system of claim 1, further including cell balancing circuit boards mounted between at least one of rows and columns of energy storage cell canisters and wiring to connect the cell balancing circuit boards to the bus bar interconnections, and wherein the shaped separator inserts, the circuit boards, and wiring are one of a modification, conversion, and retrofit kit for an ultracapacitor module.

7. The system of claim 1, wherein the energy storage cell canisters are ultracapacitors.

8. The system of claim 1, wherein the energy storage cell canisters are batteries.

9. The system of claim 1, wherein the energy storage cell canisters are shaped as a cylinder.

10. The system of claim 1, wherein the energy storage cell canisters are shaped as square cans.

11. The system of claim 1, wherein one or more shaped separator inserts extend along the outer surface of the energy storage cell canisters.

12. The system of claim 1, wherein more than one of the bus bar interconnections have different lengths.

13. The system of claim 1, wherein more than one of the shaped separator inserts have different widths.

14. The system of claim 1, wherein the shaped separator inserts include grooves to mount circuit boards at least partially therein.

15. The system of claim 1, wherein the energy storage cell canisters are organized in at least one of rows and columns, and further including circuit boards disposed parallel relative to central longitudinal axis of the energy storage cell canisters in respective spaces between at least one of rows and columns.

16. The system of claim 15, wherein more than one of the circuit boards are different.

17. The system of claim 15, wherein the circuit boards also contain circuits for reporting the module status external to the multi-cell energy storage module.

18. The system of claim 1, wherein the energy storage cell canisters are organized in at least one of rows and columns, and the shaped separator inserts extend substantially the entire length of at least one of rows and columns in spaces between at least one of rows and columns.

19. The system of claim 1, wherein the energy storage cell canisters are organized in at least one of rows and columns, and the shaped separator inserts extend adjacent both ends of the energy storage cell canisters in spaces between at least one of rows and columns.
